(19) United States
(12) Patent Application Publication
(10) Pub. No.: US 2010/0307022 A1
(43) Pub. Date: Dec. 9, 2010

(54) DRYING APPARATUS AND METHOD FOR SILICON-BASED ELECTRONIC CIRCUITS

(76) Inventor: Gisulfo Baccini, Mignagola di Carbonera (IT)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/666,525

(22) PCT Filed: Jun. 26, 2007
(86) PCT No.: PCT/IT07/00454

§ 371 Date: Aug. 26, 2010

(51) Int. Cl. F26B 5/00; F26B 3/00

(52) U.S. Cl. 34/442; 34/560; 34/201

(57) ABSTRACT

A drying apparatus (10) for silicon-based electronic circuits (30), in particular photovoltaic cells, comprises a drying oven (20) having a drying chamber (46) provided with an entrance aperture (19), through which the silicon-based electronic circuits (30) are introduced therein so as to be subjected to at least a drying cycle, and with an exit aperture (21), through which the silicon-based electronic circuits (30) are removed and in which drying chamber (46) a drying means (50) is disposed, in order to dry the silicon-based electronic circuits (30); and movement means (14) in order to move the silicon-based electronic circuits (30) inside the drying chamber (46) in a direction of advance (X), between the entrance aperture (19) and the exit aperture (21). The movement means (14) comprises closed ring means (22) on which a plurality of support members (12) are able to be mounted, each of which comprises a plurality of supporting elements (16) disposed one on top of the other and on each of which one of said silicon-based electronic circuits (30) is able to be positioned. The actuation means (25) is connected to the closed ring means (22) so as to impart to the support members (12) a determinate speed of advance inside the drying chamber (46), correlated to the duration of the drying cycle.

### FIELD OF THE INVENTION

The present invention concerns an apparatus and the relative method for baking or drying silicon-based electronic circuits, mono- or multi-layer, in particular but not only such as photovoltaic cells.

### BACKGROUND OF THE INVENTION

Mono- or multi-layer electronic circuits are known, based on silicon or aluminum oxide, in particular but not only such as photovoltaic cells.

Photovoltaic cells of this type generally have sizes of about 16 cm by 16 cm, but can also be smaller, and are usually subjected to drying in suitable drying apparatuses of a known type.

Known drying apparatuses comprise an oven with a substantially rectilinear development which is provided with a drying chamber kept at a determinate temperature, or with two or more zones in sequence at defined and differentiated temperatures, in which each zone has a specific temperature and the relative contiguous zone has a temperature correlated to the required drying and/or baking cycle.

A conveyor belt, normally with links, but also of other types, on which the electronic circuits are deposited one by one in sequence, enters the oven and advances continuously, making the circuit to be dried and/or baked remain in the oven for the time required in order to effect a determinate drying cycle, typically for about 45 minutes.

One disadvantage of these known apparatuses is that, in order to have limited sizes and supposing an overall plane bulk of each electronic circuit of about 20 cm by 20 cm, they have limited productivity, in the range of a couple of hundred pieces per hour.

On the contrary, to obtain high productivity, for example between 1000 and 3000 pieces per hour, the apparatuses must be very long, for example between 200 and 600 meters and with very high speeds of transit of the circuits, for example between 4 and 13 meters per minute, and are therefore uneconomical and practically unachievable.

Furthermore, the considerable speed of movement of the electronic circuits along the belt entails the risk that the circuits, being so light, can be carried away from the belt. To prevent this, it is known to use suction devices associated with the belt, which on the one hand keep the electronic circuits adherent to the belt but on the other hand make the oven more complex and expensive.

A device is also known, from the European patent EP-B-1.041.865 in the name of the present Applicant, for producing multi-layer electronic circuits having a drying oven inside which the circuits are made to advance at an intermittent speed, step-wise. However, this known oven does not allow high productivity either.

Purpose of the present invention is therefore to overcome the shortcomings of the state of the art and to achieve a drying apparatus for silicon-based electronic circuits which allows high productivity, in the range of some thousands of pieces per hour, which does not occupy much space, or in any case is compatible with the typical sizes of an industrial warehouse, also to reduce the heat necessary for baking, to reduce the material necessary, to reduce the bulk and the complexity of construction and to improve the drying and/or baking cycle.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, a drying apparatus for silicon-based electronic circuits, in particular photovoltaic cells, comprises a drying oven having a drying chamber provided with an entrance aperture, through which the silicon-based electronic circuits are able to be introduced into the drying chamber so as to be subjected to at least one drying cycle, and an exit aperture through which the silicon-based electronic circuits are able to be removed and in which drying chamber a drying means is disposed, able to dry the silicon-based electronic circuits. The drying apparatus also comprises movement means able to move the silicon-based electronic circuits inside the drying chamber in a direction of advance, between the entrance aperture and the exit aperture.

According to a characteristic feature of the present invention, the movement means comprises closed ring means on which a plurality of support members are able to be mounted, each of which comprises a plurality of supporting elements disposed one on top of the other and on each of which one of the silicon-based electronic circuits is able to be positioned. Moreover, an actuation means is connected to the closed ring means in order to impart to the support members a determinate speed of advance inside the drying chamber, correlated to the duration of the drying cycle.

Advantageously, each support member can carry a number of electronic circuits comprised between about 40 and 60, or even more.

The drying apparatus according to the invention thus has higher productivity, in the range of some thousands of pieces per hour, because in the time corresponding to the duration of one drying cycle a plurality of silicon-based electronic circuits are dried, many more than those allowed by state of the art apparatuses.

Moreover, the apparatus according to the present invention takes up little space, because in order to increase productivity it is not necessary to implement very long or parallel baking lines.

In this way, the heat needed for drying is also reduced, and also the necessary material, the overall bulk and the complexity of construction, and the drying and/or baking cycle is improved.

Advantageously, the drying chamber has a length comprised between about 8 meters and 12 meters, with a transit speed for the circuits of between about 16 and 30 cm per minute, for a drying time comprised between about 40 and 50 minutes.

According to the present invention, since the oven is relatively short, reduced speeds of movement are determined, for example between about 16 centimeters per minute and 30 centimeters per minute, while in any case high productivity is maintained, thanks to the support members provided.

Given the reduced speed of advance allowed by the present invention, and the fact that the movement of the support members is uniform, the operator can easily and instantly load the support members onto the relative movement means.

An advantageous embodiment of the invention provides that on the closed ring means a plurality of plates are mounted, advantageously at a pre-determined distance from each other, disposed in succession and on which the support members are positioned, thus functioning as a conveyor belt which extends from entrance to exit. Alternatively, it is possible to use a conveyor belt proper or a moving mat.

Advantageously, the support member is of the type with a rack or comb, and its supporting elements have sizes coherent with those of the silicon-based electronic circuits to be processed.

According to a variant, the support members are coupled in pairs in a direction orthogonal to the length of the closed ring means. According to this variant, the support members spread apart from each other from the base to the top, in order to facilitate the entry of the recircled air inside the oven. Advantageously, in this case a supporting bar is provided along the support member which also allows to keep the silicon-based electronic circuits balanced on the supporting elements, preventing them from falling.

According to another variant, the support members are coupled in threes, in a direction orthogonal to the length of the closed ring means. According to this variant, the central support member is positioned vertically on the transporter and the two support members spread apart widening from the base towards the top.

According to another variant, the support members are located on a channel which holds them raised with respect to the transport chain.

The channel has holes for the circulation of the heating fluid both at the sides and above, and has heads, substantially parallel with the edge of the transport chain, open to facilitate the transit of the heating fluid.

According to another variant, the oven is divided into zones or sections having differentiated drying temperatures. Each zone has an entrance door and a corresponding exit door through which the conveyor belt advances step-wise. Moreover, each zone has a temperature and number of support members present at that moment in the section which are coordinated and coherent with the drying and/or baking cycle provided.

The method for drying silicon-based electronic circuits according to the invention comprises a first step in which the silicon-based electronic circuits are positioned on said supporting elements of each support member, a second step in which the support members are moved by means of the movement means inside the drying oven, a third step in which the drying cycle is performed of the silicon-based electronic circuits contained in the support members and a fourth step in which the support members are moved outside the drying oven by the movement means.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a lateral view of a drying apparatus according to the present invention;

FIG. 2 is a section from II to II of FIG. 1;

FIG. 3 is an enlarged detail of FIG. 1;

FIG. 4 is a view of part of the apparatus in FIG. 1;

FIG. 5 is an enlarged detail of FIG. 2, in which the apparatus is partly open;

FIG. 6 is a section of the apparatus in FIG. 1;

FIG. 7 is a three-dimensional view of the apparatus in FIG. 1; and

FIG. 8 is an enlarged detail of FIG. 7.

### DETAILED DESCRIPTION OF A PREFERENTIAL FORM OF EMBODIMENT

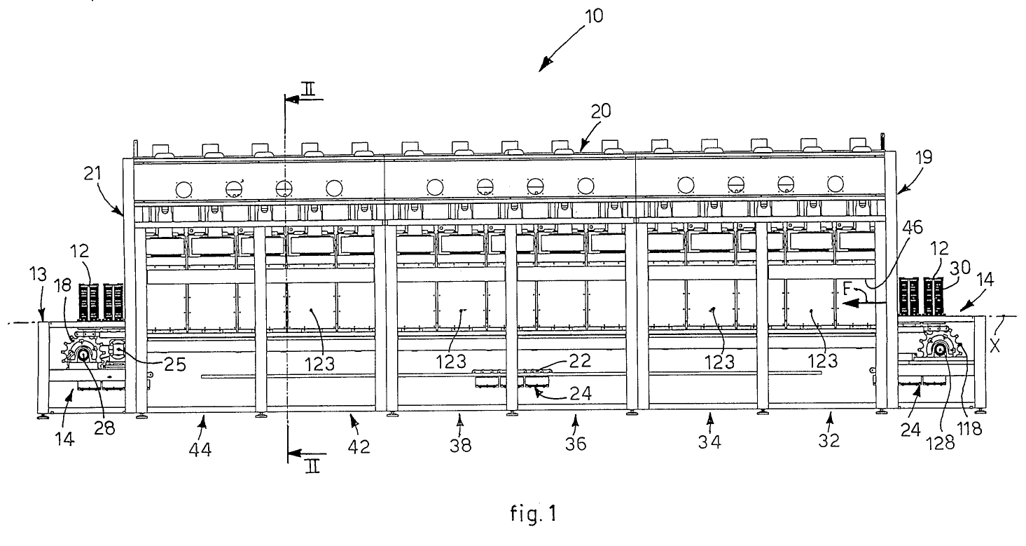

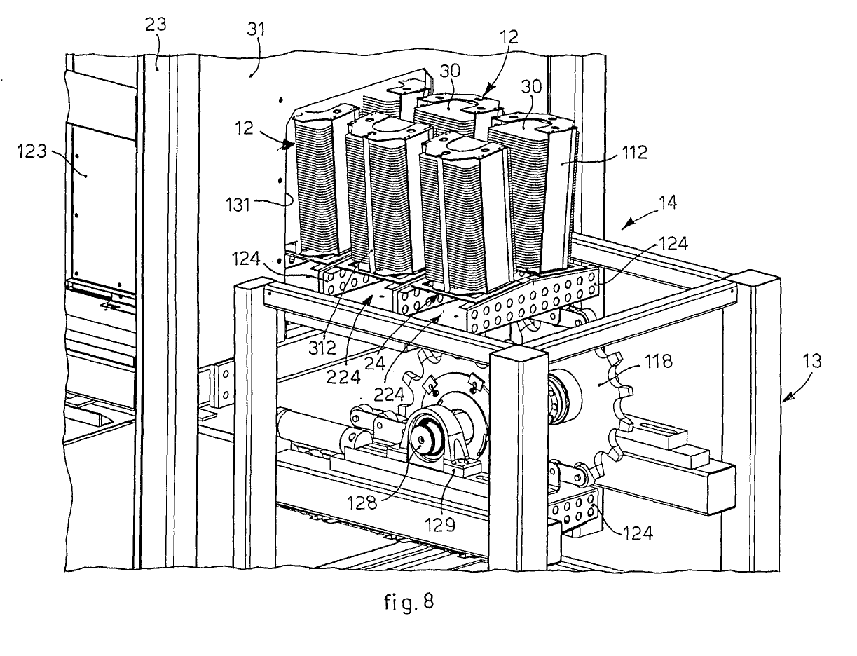

With reference to FIG. 1, a drying apparatus 10 comprises a drying oven 20, with a substantially rectilinear development, to effect a cycle for drying silicon wafers 30 for photovoltaic cells, visible in FIG. 8, with a plane size of about 16 cm by 16 cm.

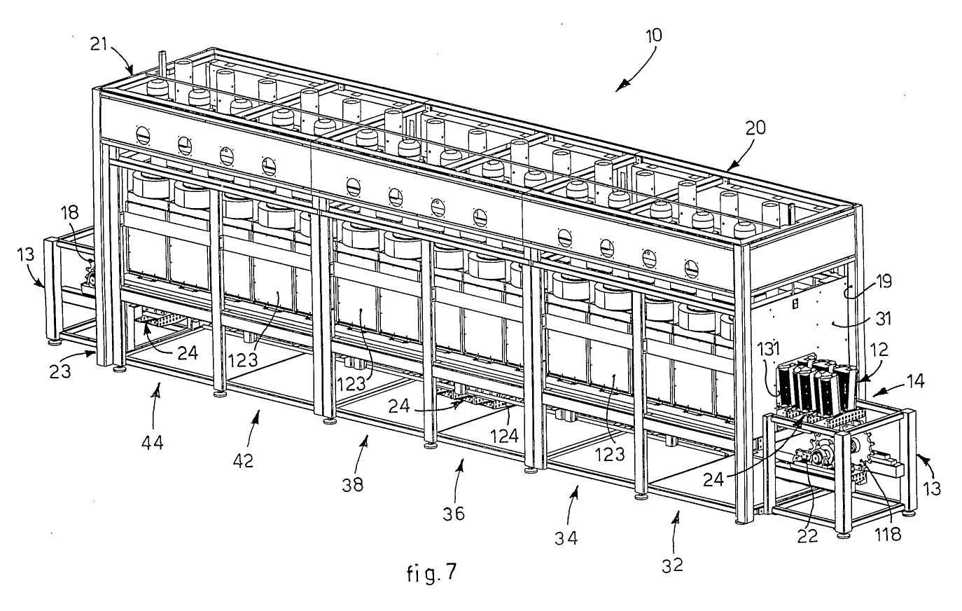

The oven is formed by a supporting frame 23 which supports walls 123 (FIG. 7) which thermally insulate the inside of the oven 20 from the outside, so as to define a drying chamber 46.

The chamber 46 has an entrance 19 through which the wafers 30 can be inserted inside the oven 20 to be dried, according to a determinate drying cycle, and an exit 21, from which the dried wafers can be removed.

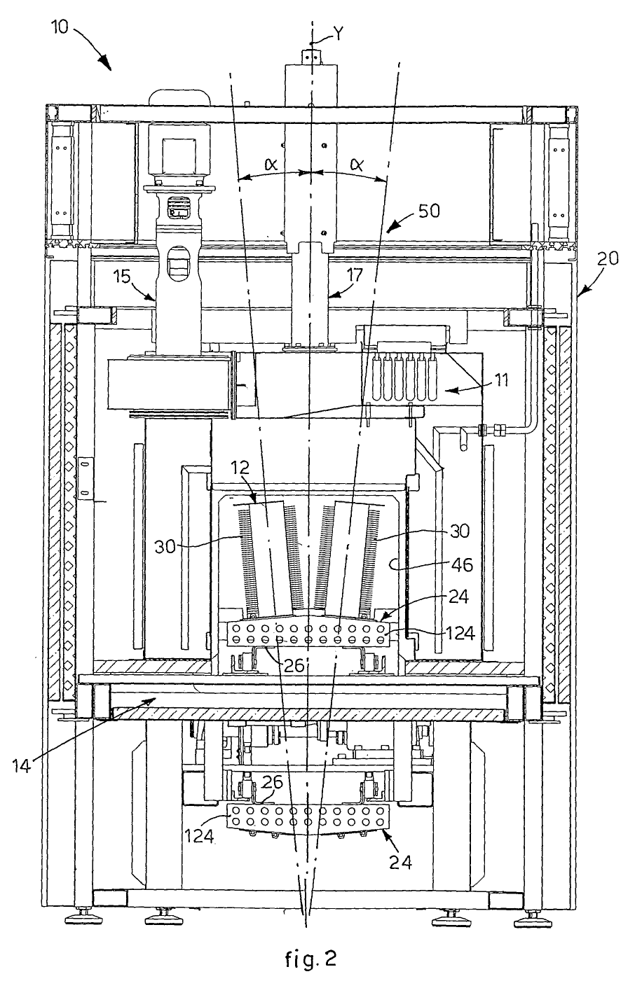

Inside the chamber 46, between the entrance 19 and the exit 21, drying units 50 are disposed in sequence (FIG. 2).

Each of the drying units 50 comprises, in a traditional manner, a suction device 15 which sucks in the air from outside, a heating device 11 which heats or in any case varies the thermodynamic properties of the air coherently with the drying cycle provided, and a soufflage device 17 which blows the drying air towards the wafers 30 and which thus defines a determinate circulation and/or re-circulation of the drying air, also coherent with the type of drying cycle.

A fixed wall 31 with an aperture 131 is provided at the entrance 19, and a relative aperture is provided at the exit 21, for the entry and exit of the wafers 30.

As an alternative to the fixed wall 31, at the entrance 19 a shutter-type door can be provided, with automatic opening and closing, advantageously timed and coordinated with the drying cycle and for the insertion of the wafers 30, and a corresponding door at the exit 21.

The oven 20 shown in the attached drawings is divided into drying zones 32, 34, 36, 38, 42, 44 with different temperatures and disposed in sequence, between the entrance 19 and the exit 21, to determine a drying temperature profile to which the wafers 30 are subjected. Each drying zone is provided with a relative drying unit 50. Advantageously, between the various zones 32, 34, 36, 38, 42, 44 intermediate separating doors can be provided, opening automatically, so as to reduce the heat dispersion between one zone and the other.

It is clear that the present invention is also applied to an oven inside which the drying temperature is maintained constant.

The apparatus 10 also comprises another supporting frame 13 to support a movement unit 14 (FIGS. 1, 2, 3 and 7), which is able to move the wafers 30 inside the oven 20 between the entrance 19 and the exit 21, along a determinate direction of advance X and the direction indicated by the arrow F (FIG. 1).

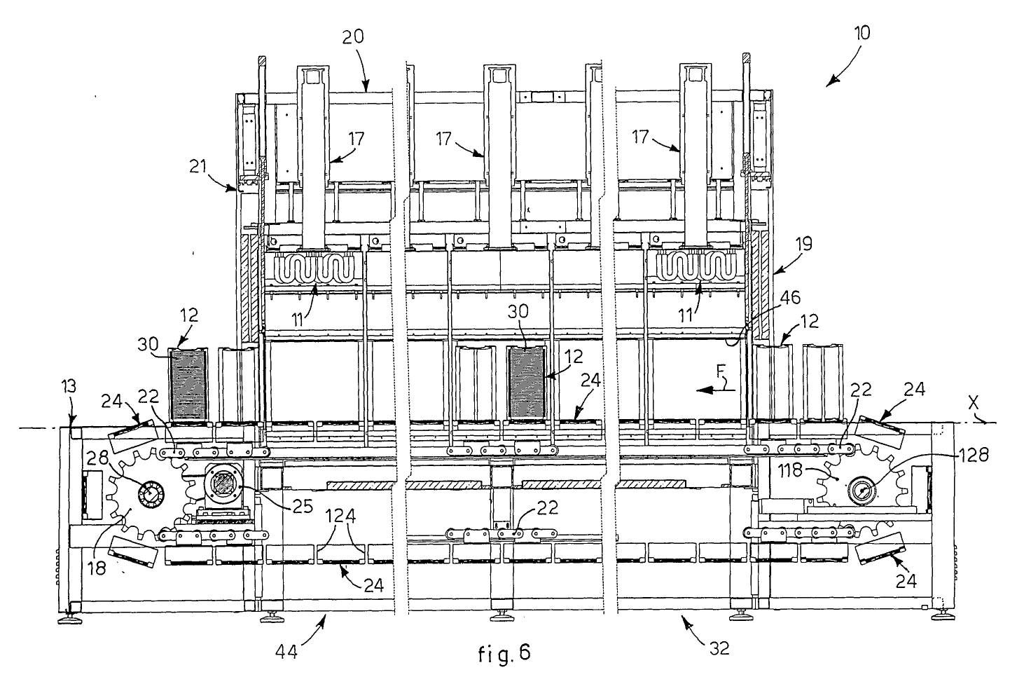

In particular, the movement unit 14 comprises a plurality of plates 24 (FIG. 2), on each of which a rack-type or comb-type container 12 is mounted (FIGS. 1, 2, 3, 4, 5, 6 and 7), and which are moved automatically between the entrance 19 and the exit 21, as will be shown in more detail hereafter in the description.

The container 12 is formed by two lateral walls 112, 212 and by a top surface 412 and a base surface 512, so as to leave two sides open through which the wafers 30 can be inserted (FIG. 4). To this purpose, each container 12 comprises a plurality of supporting guides 16 (FIG. 4), disposed in pairs on top of both walls 112, 212 of the container 12, on which the wafers 30 are able to rest. In this way, the wafers 30 are positioned stacked in the container 12, distanced from each other, advantageously one parallel to the other, so as to allow the drying air to pass, and at the same time with great packing density, so as to have high productivity for every drying cycle. In fact, for example in the solution shown here, each container 12 can contain about 50 wafers 30 or even more.

Each container 12 is positioned so as to be inclined by a determinate angle α, for example comprised between about 0° and 10°, with respect to an axis Y orthogonal to the direction of advance X of the containers 12 (FIG. 2).

This inclination allows greater effectiveness in the circulation of the air and therefore a greater efficiency in drying.

To prevent the wafers 30 from falling from the containers 12 thus inclined, a supporting bar 312 is provided, disposed along the whole height of the container 12, from the base 512 to the top 412 (FIG. 4), on which the wafers 30 rest.

To automatically displace the containers 12 along the oven 20, each plate 24 of the movement unit 14 is connected by means of brackets 26 (FIGS. 2 and 5), to a closed ring or conveyor belt chain 22 (FIGS. 1, 3, 6 and 7), which extends mainly in length in the direction of advance X.

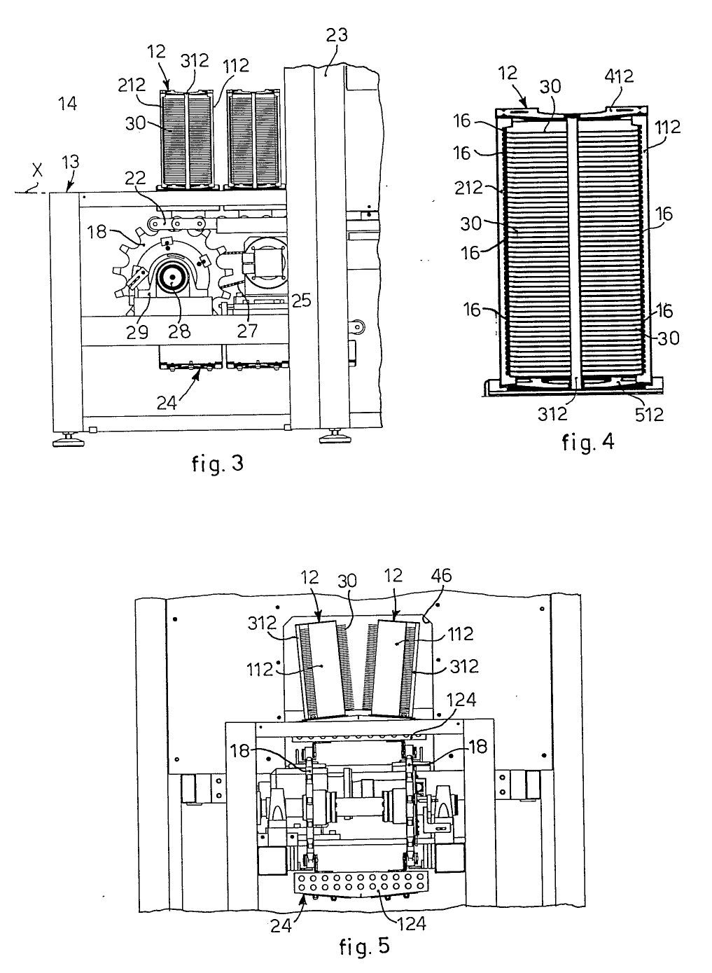

The ring type chain 22 is coupled with two toothed wheels 18, 118, mounted rotatably, by means of hubs 28, 128, on suitable supports 29, 129 (FIGS. 3 and 8) associated with the frame 13; the first wheel 18 is located at the exit 21 of the oven 20, the second wheel 118 is located at the entrance 19 to the oven 20. The toothed wheel 18 is made to rotate directly, by means of a transmission chain 27 (FIG. 3) connected to its hub 28, by a motor 25, whereas the toothed wheel 118 is driven in rotation by the ring-type chain 22. The motor 25 is thus connected to the chain 22 in order to impart to the containers 12 a determinate speed of advance, correlated to the duration of the drying cycle.

When one drying cycle is complete, that is, when the relative container 12 and the wafers 30 contained therein have been transported from the entrance 19 to the exit 21, each plate 24 automatically returns to the entrance 19 along the closed ring circuit imposed by the chain 22, so as to be loaded again with a container 12, and so on.

In the solution shown here, between each plate 24 and the relative bracket 26 holed walls 124 are provided (FIGS. 2, 5 and 8), disposed vertically, which thus define channels 224 (FIG. 8) perpendicular to the direction of advance X of the containers 12, to facilitate the circulation of air both cross-wise and parallel to said direction.

The speed at which the chain 22 transports the containers along the inside of the oven 20 is correlated to the type of drying cycle provided. In this way, the present invention allows to effect stops with a pre-determined duration, intermittent advance, in correspondence with one or more drying zones 32, 34, 36, 38, 42, 44 at different temperatures, so as to effect a movement at a determinate constant speed, or according to a determinate trend of speed, increasing or decreasing, a combination of acceleration and deceleration, or other.

The speed of advance given by the motor 25 during the drying cycle, the opening and closing of the possible entrance, exit and intermediate doors, and also the functioning of the drying units 50, are advantageously controlled automatically by means of an electronic-type control unit, not shown in the drawings, according to the drying cycle selected.

The method to dry the wafers 30 according to the invention therefore provides to insert the wafers 30 resting on the relative guides 16 of each container 12 and to position, for example manually by an operator or by means of a loading robot, “on the fly”, that is, in continuous sequence, or during the possible stops of the chain 22, a plurality of containers 12 thus loaded in correspondence with the entrance 19 of the oven 20, preferably two containers 12 for each plate 24, disposed inclined as described above, or, according to a variant not shown, three containers 12, one central and two lateral and inclined.

Subsequently, each container 12 is moved continuously inside the oven 20 and correspondingly another plate 24 is made available at the entrance 19, so as to load thereon two more containers 12. The wafers 30 loaded on the containers 12 are subjected to the selected drying cycle and, finally, are removed from the oven 20 through the exit 21. By loading the containers 12 on each plate 24 that is made ready at the entrance 19, the oven 20 is able to operate continuously, drying the wafers 30 according to a pre-determined drying cycle with high productivity.

For example, with a drying chamber 46 about 10 meters in length, a drying time of about 45 minutes, a speed of continuous movement of about 22 cm per minute and using paired containers 12 each one having a plane bulk of about 25 cm by about 25 cm, a height of about 60 cm and on each of which 50 wafers are disposed, we have a productivity of about 5300 pieces dried per hour. Moreover, the speed of movement is relatively low and compatible with the height of the containers 12, so as to prevent unwanted oscillations during transit.

It is clear that modifications and/or additions of parts and/or steps may be made to the apparatus and method for drying silicon-based electronic circuits as described heretofore, without departing from the field and scope of the present invention.

It is also clear that, although the present invention has been described with reference to specific examples, a person of skill in the art shall certainly be able to achieve many other equivalent forms of apparatus and method for drying silicon-based electronic circuits, having the characteristics as set forth in the claims and hence all coming within the field of protection defined thereby.

1.-20. (canceled)

21. An apparatus for drying wafers, comprising:
a drying oven comprising a drying chamber having an entrance aperture and an exit aperture that are aligned along a first direction;
a movement unit configured to move the wafers through the drying chamber between the entrance aperture and the exit aperture, wherein the movement unit comprises:
a closed ring device on which a plurality of containers are disposed, wherein the containers are disposed at a first angle with respect to a second direction that is orthogonal to the first direction, and each of the containers comprise a plurality of supporting guides configured to receive a wafer thereon; and
an actuation unit coupled to the closed ring device that is configured to control the speed of the containers through the drying chamber; and
a drying unit configured to deliver heat to the wafers disposed in a container that is disposed in the drying chamber.

22. An apparatus for drying wafers, comprising:
a drying chamber having an entrance aperture and an exit aperture that are aligned along a first direction;
a closed ring device configured to move a container having a plurality of wafers disposed therein through the drying chamber, wherein the container is disposed on the closed ring device at a first angle with respect to a second direction that is orthogonal to the first direction, and wherein the container comprises a plurality of supporting guides configured to receive a wafer thereon; and
a drying unit configured to deliver heat to the wafers disposed in the container that is disposed in the drying chamber.

23. The apparatus of claim 22, wherein the closed ring device further comprises a plurality of supporting plates that are each configured to receive at least one of the containers.

24. The apparatus of claim 23, wherein each support plate is configured to receive a first container and a second container that are aligned in an adjacent orientation that is orthogonal to the first direction.

25. The apparatus of claim 23, wherein each support plate is configured to receive a first container, a second container and a third container that are each aligned along a third direction that is orthogonal to the first direction.

26. The apparatus of claim 25, wherein the third containers is positioned vertically and centrally between the first container and the second container.

27. The apparatus of claim 23, wherein each of the supporting plates has two adjacent walls which define a channel through which air can pass.

28. The apparatus of claim 22, wherein the container has between about 40 and 60 supporting guides that are each configured to receive at least a portion of a wafer.

29. The apparatus of claim 21, wherein the container has at least an open side for loading the wafers onto a plurality of supporting guides disposed in an inner volume, and wherein each of the plurality of supporting guides are positioned a predefined distance from each other inside the inner volume of the container.

30. The apparatus of claim 21, wherein the drying unit comprises a heating device and a soufflage device, wherein the soufflage device is configured to deliver air towards the wafers disposed in a container disposed on the closed ring device.

31. The apparatus of claim 21, wherein the drying oven further comprises a plurality of drying zones that are each disposed along the first direction and each comprise a drying unit, wherein the temperature of a flow of air delivered from each drying unit in each of the plurality of drying zones is different.

32. A method of drying wafers, comprising:
positioning a container having a plurality of wafers disposed therein on a movement unit;
moving the container through a drying oven in a first direction at a desired speed using an actuation device that is coupled to the movement unit, wherein the container is inclined at a first angle with respect to a second direction which is orthogonal to the first direction; and
drying the wafers using a drying means that is coupled to the drying chamber.

33. The method as in claim 32, wherein positioning the container further comprises inserting each of the wafers on supporting guides so that each of the wafers are disposed a distance apart.

34. The method as in claim 32, wherein moving the container comprises moving the container at a speed between about 16 centimeters per minute and 30 centimeters per minute.

35. The method as in claim 32, wherein the wafers are photovoltaic cells or silicon-based electronic circuits.

36. Method as in claim 32, wherein the plurality of wafers are between about 40 and 60.
